(19) United States
(12) Patent Application Publication
(10) Pub. No.: US 2026/0089465 A1
(43) Pub. Date: Mar. 26, 2026

(54) UWB POSITIONING METHOD, AND MANAGEMENT SERVER OPERATING METHOD AND SYSTEM THEREFOR

(71) Applicants: Hyundai Motor Company, Seoul (KR); Kia Corporation, Seoul (KR)

(72) Inventor: Yong Seok JEONG, Hwaseong-Si (KR)

(21) Appl. No.: 19/254,496

(22) Filed: Jun. 30, 2025

(30) Foreign Application Priority Data
Sep. 23, 2024 (KR) 10-2024-0128441

(51) Int. Cl. H04W 4/029; B60R 25/24; G07C 5/02; H04W 4/40; H04W 4/80

(52) U.S. Cl. CPC H04W 4/029; H04W 4/40; H04W 4/80; B60R 25/245; B60R 2325/101; G07C 5/02

(57) ABSTRACT

A method performed by an apparatus for a vehicle may comprise obtaining parking location information of the vehicle and providing the parking location information to a user terminal. After providing the parking location information and after the user terminal is wirelessly disconnected from the vehicle, the method may comprise transmitting, using a Bluetooth Low Energy (BLE) transceiver of the vehicle, a BLE signal that may comprise the parking location information. After transmitting the BLE signal, the method may comprise determining whether access information of the user terminal is received from a server. Based on a determination that the access information is received, the method may further comprise initiating, using an ultra-wideband (UWB) transceiver of the vehicle, a UWB communication connection between the vehicle and the user terminal.

### CROSS-REFERENCE TO RELATED APPLICATION

This application claims the benefit of priority to Korean Patent Application No. 10-2024-0128441 filed in the Korean Intellectual Property Office on Sep. 23, 2024, the entire contents of which are hereby incorporated by reference.

### FIELD

The present disclosure relates to an ultra-wideband (UWB) positioning method to recognize a digital key between a vehicle owned by a user and a registered user terminal, and a management server operating method and system therefor.

### BACKGROUND

The matters described in this Background section are only for enhancement of understanding of the background of the disclosure, and should not be taken as acknowledgment that they correspond to prior art already known to those skilled in the art.

Technological advances are making available a variety of vehicle amenities. For example, a user may use their digital key (including a smartphone) to control the start of a vehicle, open/close the doors of the vehicle, or regulate the temperature in the vehicle.

In this regard, a communication protocol for data exchange between the digital key and the vehicle may be standardized, for example, the standard of which adopts the car connectivity consortium (CCC) standard. In accordance with a communication protocol defined in the CCC standard, an original equipment manufacturer (OEM) of each vehicle and an OEM of each smartphone may be developing their products.

In the case of a digital key using general Bluetooth Low Energy (BLE) and ultra-wideband (UWB), a smartphone (i.e., a portable user terminal) that supports BLE and UWB communication may be used to track the location of a user and provide functions such as opening and closing doors of a vehicle and starting the engine of the vehicle based on the tracked location.

To perform UWB communication, BLE communication may be first performed to set the parameters of UWB communication. For example, BLE communication may be used to allow the smartphone and the vehicle to share the parameters of UWB communication therebetween.

In addition, BLE communication may be used for vehicle control using typical radio frequency (RF) when there is an attempt to perform a function using BLE communication between the smartphone and the vehicle. For example, in the case of typical remote keyless entry (RKE), BLE communication may be used to implement the function of opening and closing the doors of the vehicle.

However, BLE communication may use the frequency band of 2.402 gigahertz (GHz) to 2.480 GHz. Using such a high frequency may cause distortion by a signal reflected from the surroundings and may thus degrade the BLE reception performance, resulting in intermittent operation or disconnection of BLE communication.

Thus, vehicle control by BLE communication may not be performed in a poor BLE communication environment as described above, and in such a case, a user may feel it as an operational delay and may thus have reduced reliability.

In an effort to overcome this, increasing the BLE transmission strength may be considered, but this may increase the current consumption of a vehicle. Therefore, a technology for enhancing or optimizing power consumption and determining a desirable or an optimal positioning start time is considered.

### SUMMARY

An object of examples of the present disclosure is to solve the challenges described above.

According to the present disclosure, a method performed by an apparatus for a vehicle, the method may comprise, obtaining parking location information of the vehicle, providing the parking location information to a user terminal, after providing the parking location information and after the user terminal is wirelessly disconnected from the vehicle, transmitting, using a Bluetooth Low Energy (BLE) transceiver of the vehicle, a BLE signal may comprise the parking location information, after transmitting the BLE signal, determining whether access information of the user terminal is received from a server, and based on a determination that the access information is received, initiating, using an ultra-wideband (UWB) transceiver of the vehicle, a UWB communication connection between the vehicle the user terminal.

The method, wherein the obtaining the parking location information may comprise obtaining, based on driving-related data, the parking location information, and wherein the user terminal is equipped with a digital key associated with the vehicle.

The method, wherein the providing the parking location information to the user terminal may comprise, providing, from the vehicle and via a short-range communication network, the parking location information to the user terminal.

The method, wherein the providing the parking location information to the user terminal may comprise, providing the parking location information of the vehicle to the user terminal via the server.

The method, wherein the parking location information is generated based on information from at least one of a wheel sensor, a steering sensor, or a gravity-sensor.

The method may further comprise, based on the UWB communication connection between the vehicle the user terminal, authenticating the user terminal to control at least one operation of the vehicle, wherein the parking location information is generated using a map of a parking space based on information from at least one of a wheel sensor, a steering sensor, or a gravity-sensor.

The method, wherein the parking location information is generated based on, information from at least one of a wheel sensor, a steering sensor, or a gravity-sensor, and information obtained through wireless communication between the vehicle and external devices located in a parking space.

The method may further comprise, causing the server to generate the access information based on the user terminal approaching a location within a preset threshold range from a parking location of the vehicle indicated by the parking location information, or causing the server to generate the access information based on the user terminal being determined to approach a location within the preset threshold range from the parking location of the vehicle, wherein the generation of the access information is based on location information of a second vehicle from which the user terminal receives a BLE signal may comprise parking location information of the second vehicle, wherein a distance between the vehicle and the second vehicle is within a predetermined threshold distance.

The method, wherein the initiating the UWB communication connection may comprise, retransmitting the BLE signal with an increased signal transmission strength, and after receiving a response responsive to the retransmitted BLE signal, initiating the UWB communication connection.

The method, wherein the initiating the UWB communication connection may comprise, gradually increasing a signal transmission strength of the BLE signal by a preset increment to a preset default value up to a preset maximum transmission strength.

The method, wherein the initiating the UWB communication connection may comprise, setting the UWB transceiver to a standby state, wherein the UWB transceiver is configured to measure a distance between the vehicle and the user terminal via UWB signaling.

The method, wherein the initiating the UWB communication connection may comprise, based on the communication connection being established between the vehicle and the user terminal, establishing a UWB communication connection with the user terminal.

According to the present disclosure, a method performed by a server, the method may comprise, based on receiving parking location information of a vehicle, storing and registering the parking location information with pre-registered digital key information, based on receiving, from a user terminal, parking location information of at least one other vehicle located within a threshold distance from the user terminal, determining a current location of the user terminal, wherein the user terminal is equipped with a digital key associated with the vehicle, and wherein the digital key corresponds to the pre-registered digital key information, determining a distance between the current location of the user terminal and a parking location of the vehicle, wherein the parking location is indicated by the parking location information of the vehicle, and based on a determination that the distance is within a preset threshold range, transmitting access information of the user terminal to the vehicle.

The method, wherein the determining the current location of the user terminal may comprise, based on only one parking location received from the user terminal, determining, based on the parking location information of the at least one other vehicle, the current location of the user terminal.

The method, wherein the determining the current location of the user terminal may comprise, based on two or more parking locations received from the user terminal, determining the current location of the user terminal by triangulation based on the two or more parking locations.

According to the present disclosure, a system for a vehicle, the system may comprise, a vehicle control circuit configured to detect an operating state of the vehicle and control the vehicle, a Bluetooth Low Energy (BLE) communication circuit configured to perform a first-type of communication with a user terminal, a ultra-wideband (UWB) communication circuit configured to perform a second-type of communication with the user terminal, a wireless communication circuit configured to communicate with a server, a processor, and a memory storing at least one instruction that, when executed by the processor communicating with the memory, is configured to cause the system to, obtain parking location information of the vehicle, provide the parking location information of the vehicle to the user terminal, after providing the parking location information and after the user terminal is wirelessly disconnected from the vehicle, transmit, using the BLE communication circuit, a BLE signal may comprise the parking location information, after transmitting the BLE signal, determine whether access information of the user terminal is received from the server, and based on a determination that the access information is received from the server, initiate, using the UWB communication circuit, a UWB communication connection between the vehicle and the user terminal.

The system, wherein the at least one instruction, when executed by the processor communicating with the memory, is further configured to cause the system to, obtain the parking location information of the vehicle from driving-related data via the vehicle control circuit, and provide the parking location information to the user terminal, wherein the user terminal is equipped with a digital key associated with the vehicle.

The system, wherein the at least one instruction, when executed by the processor communicating with the memory, is configured to cause the system to initiate the UWB communication connection by, retransmitting the BLE signal with an increased signal transmission strength, and after receiving a response responsive to the retransmitted BLE signal, initiating the UWB communication connection.

According to the present disclosure, a method performed by a user terminal associated with a vehicle, the method may comprise, while the vehicle is in a parked state, receiving parking location information of the vehicle, after receiving the parking location information and after the user terminal is wirelessly disconnected from the vehicle, receiving, using a Bluetooth Low Energy (BLE) transceiver of the user terminal, a BLE signal may comprise parking location information of a second vehicle, after receiving the BLE signal, transmitting, to a server, a wireless signal that causes an increase of a BLE signal transmission power for BLE signal transmission of the vehicle, after transmitting the wireless signal to the server, receiving, using the BLE transceiver, a second BLE signal may comprise parking location information of the vehicle, and based on receiving the second BLE signal, initiating, using a ultra-wideband (UWB) transceiver of the user terminal, a UWB communication connection between the vehicle the user terminal.

The method, wherein the wireless signal indicates at least one of a location of the user terminal, the parking location information of the second vehicle, or the reception of the BLE signal, and wherein a distance between the vehicle and the second vehicle is within a predetermined threshold distance.

### BRIEF DESCRIPTION OF THE DRAWINGS

FIG. 1 shows an example of a communication network to which an ultra-wideband (UWB) positioning method based on a method of transmitting a parking location of a vehicle of a user and a method of recognizing a current location of the user is applied, according to an example of the present disclosure.

FIG. 2 shows an example of the process and concept of a UWB positioning method according to an example of the present disclosure.

FIG. 3 shows an example of a communication-related system of vehicles shown in FIG. 1.

### DETAILED DESCRIPTION

Hereinafter, examples of the present disclosure will be described in detail with reference to the accompanying drawings. The examples are not construed as limited to the disclosure and should be understood to include all changes, equivalents, and replacements within the idea and the technical scope of the disclosure.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

Although terms including ordinal numbers, such as, “first,” “second,” and the like, may be used herein to describe various elements, the elements are not limited by these terms. These terms are only used to distinguish one element from another.

The term “and/or” is used to include any combination of multiple items that are subject to it. For example, “A and/or B” may include all three cases, for example, “A,” “B,” and “A and B.” For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

When an element is described as “coupled” or “connected” to another element, the element may be directly coupled or connected to the other element. However, it is to be understood that another element may be present therebetween. In contrast, when an element is described as “directly coupled” or “directly connected” to another element, it is to be understood that there are no other elements therebetween.

The singular forms “a,” “an,” and “the” are intended to include the plural forms as well, unless the context clearly indicates otherwise. It is to be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

In addition, the term “unit,” “control unit,” “control device,” or “controller” is merely a widely used term for naming an element that controls a specific function, and does not mean a generic functional unit. For example, each controller may include a communication device that communicates with another controller or a sensor to control a function assigned thereto, a memory that stores an operating system (OS), a logic command, input/output information, and the like, and one or more processors that perform determination, calculation, computation, decision, and the like that are necessary for controlling a function assigned thereto.

Meanwhile, a processor may include a semiconductor integrated circuit and/or electronic devices that perform at least one or more of comparison, determination, computation, and decision to achieve programmed functions. The processor may be, for example, any one or a combination of a computer, a microprocessor, a central processing unit (CPU), an application-specific integrated circuit (ASIC), an electronic circuitry, and a logic circuitry.

In addition, computer-readable recording media (or simply memory) include all types of storage devices that store data readable by a computer system. The storage devices may include at least one type of, for example, flash memory, hard disk, micro-type memory, card-type (e.g., secure digital (SD) card or extreme digital (XD) card) memory, random-access memory (RAM), static RAM (SRAM), read-only memory (ROM), programmable ROM (PROM), electrically erasable PROM (EEPROM), magnetic RAM (MRAM), magnetic disk, or optical disc.

This recording medium may be electrically connected to the processor, and the processor may load and record data from the recording medium. The recording medium and the processor may be integrated or may be physically separated.

According to the technical background of the present disclosure, Bluetooth may conform to the IEEE 802.15.1 standard as the industry standard for personal area networks (PANs), and may allow various devices to communicate with each other using secure, low-cost, globally available wireless frequency (or radio frequency (RF)).

Bluetooth uses the industrial, scientific, and medical (ISM) frequency band of 2.45 gigahertz (GHz), and has evolved by adding new features, such as, versions 1.1, 1.2, 2.0+EDR (Enhanced Data Rate), 2.1+EDR, 3.0+HS (High Speed), 4.0, and 4.1. A new low-power (e.g., Bluetooth Low Energy (BLE)) protocol stack has been proposed from Bluetooth 4.0. Here, “Bluetooth Smart Ready” for power hosts and “Bluetooth Smart” for sensors are provided.

A chip that supports only BLE may be referred to as single mode, and a product that supports and has only one-way transmission may also be referred to as Bluetooth Smart. A chip that is provided along with classic Bluetooth may be referred to as dual mode, and a product that supports and has two-way transmission may also be referred to as Bluetooth Smart Ready.

In addition, advancements in low-power wireless technology have made various wireless products commercially available. Among them, Bluetooth communication-based products are being fused with smartphones and gradually expanded to wearable devices.

In general, an advertising channel of low-power Bluetooth (e.g., BLE) may be received by any Bluetooth device that supports the BLE protocol stack. In particular, BLE beacons may broadcast data and receive it by an unspecified number of BLE scanning devices. In this case, when security is required between BLE devices, most of them may attempt to establish a BLE communication connection and encrypt the data.

Further, BLE may be a communication technology that enables low-power and low-capacity data transmission and reception in the frequency band of 2.4 GHz with a reach range (or radius) of about 10 meters (m), whereas ultra-wideband (UWB), which is a short-range wireless communication protocol that operates within a reach range of about 100 m via radio waves at higher frequencies, may be a communication technology that is used for positioning (or localization) (e.g., location and/or distance measurement (ranging)) through two-way communication.

Hereinafter, a UWB positioning method based on a method of transmitting a parking location of a vehicle of a user and a method of recognizing a current location of the user, according to examples of the present disclosure, will be described in detail with reference to the accompanying drawings.

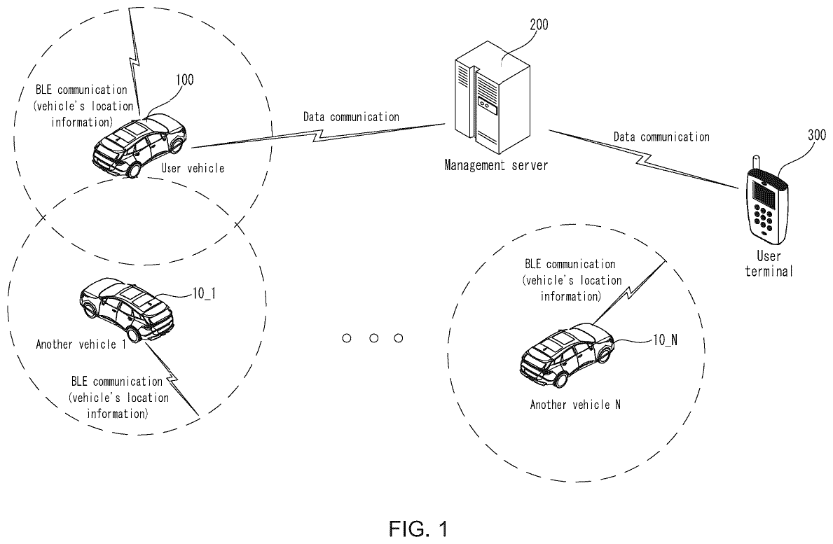

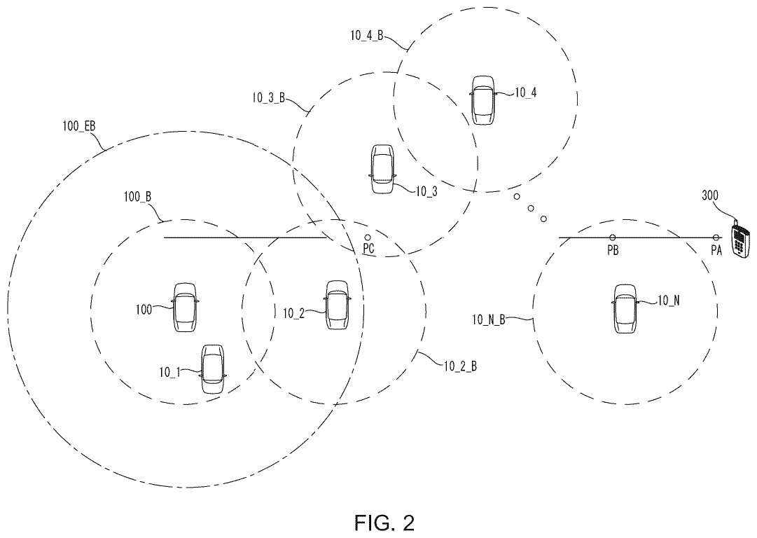

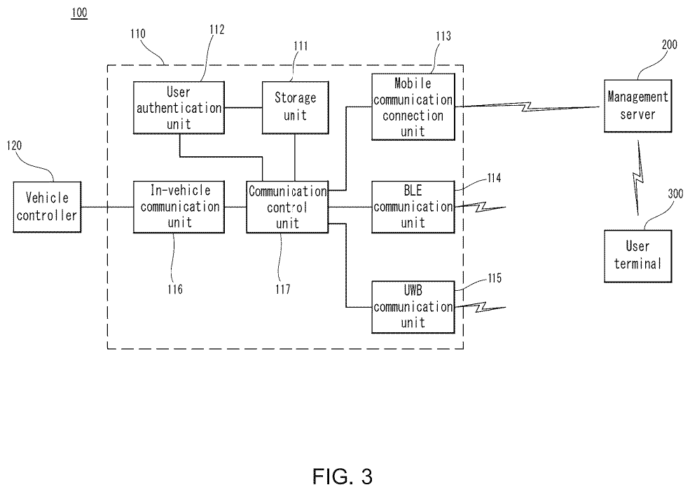

FIG. 1 shows an example of a communication network to which a UWB positioning method based on a method of transmitting a parking location of a vehicle of a user and a method of recognizing a current location of the user is applied according to an example of the present disclosure, FIG. 2 shows an example of the process and concept of a UWB positioning method according to an example of the present disclosure, and FIG. 3 shows an example of a communication-related system of vehicles shown in FIG. 1. The term “parking location” used herein may refer to a parked location at which a vehicle is parked.

Referring to FIG. 1, a communication network system to which the UWB positioning method according to an example of the present disclosure is applied may have a technical challenge of enabling a user vehicle 100 to recognize the location of a user terminal 300 that is out of a recognition range of a short-range communication network (e.g., BLE, NFC, or UWB, etc.).

Solving this technical challenge may require a reference (or criterion) based on which the location of the user terminal 300 is specified, and may also require a technique for calculating a detailed location based on the reference (e.g., coordinate triangulation, signal strength estimation, or proximity detection, etc.).

Therefore, the present disclosure proposes a positioning technology as follows.

First, to specify the location of the user terminal 300, the coordinates of each vehicle parked in a parking lot may be used for the reference. For this purpose, each vehicle may need to recognize its own plane coordinates (x, y) in the space in which each vehicle is currently parked (e.g., indoor parking level and row position, etc.) and provide it to the user terminal 300.

Therefore, it is noted herein that the present disclosure proposes a vehicle parking location transmission method in which each vehicle (but, not necessarily vehicles of all manufacturers) transmits information about a parking location of the vehicle (e.g., each vehicle) through an advertising function under the BLE communication protocol (e.g., via BLE advertising channels such as ADV_IND, ADV_NONCONN_IND, or ADV_EXT_IND, etc.).

To this end, any vehicle may perform a step of acquiring parking location information of the vehicle based on a driving route and a step of transmitting the parking location information through the advertising function of BLE communication (e.g., by encoding location data in a payload part of BLE ADV packets, etc.).

In this case, the parking location information may be generated based on information from a wheel sensor (e.g., wheel speed sensor, odometer, or ABS sensor, etc.), a steering sensor (e.g., steering angle sensor, torque sensor, or yaw rate sensor, etc.), and a G-sensor e.g., accelerometer, tilt sensor, or inertial measurement unit (IMU), etc.). Here, the parking location information in a parking space may be generated by using information acquired through communication between the infrastructures of the parking space, i.e., information of pillars in the parking space (used for recognizing coordinates, indicated as, e.g., A2 and B3) and plane information of the parking space, based on a vehicle-to-infrastructure (V2I) technology (e.g., data exchanged with parking garage beacons, cameras, or RFID tags, etc.).

On the other hand, when a detailed map is not available, a coordinate value ((x, y)=(n, m) on the plane coordinates) of the parking location may be calculated based on driving information through the information from the wheel sensor, the steering sensor, and the G-sensor, using global positioning system (GPS) information (longitude and latitude) as a starting point ((x, y)=(0, 0) on the plane coordinates) based on an entry into the parking pace (e.g., when recognized horizontally through the G-sensor, or inferred by braking patterns or engine-off events, etc.).

Based on this, the GPS information (longitude and latitude) may be inversely calculated to acquire an estimated value (e.g., using dead-reckoning techniques, IMU fusion, or map-matching algorithms, etc.) because a GPS signal is not able to be recognized in the case of an underground parking lot, and the estimated value may be used as the parking location information (e.g., parking slot, aisle number, or floor level, etc.).

In this way, after each vehicle to which the technology disclosed herein is applied acquires information about a parking location, each vehicle may embed the acquired parking location into an advertising signal of BLE communication and transmit it (e.g., in the payload field of ADV_IND or ADV_EXT_IND packets, etc.).

In this case, the strength of the advertising signal of BLE communication may be maintained at a preset default level (e.g., −12 dBm, −8 dBm, or another low-power setting, etc.), and therefore, even if the parking location information of a vehicle described above is embedded and broadcasted, no additional power consumption may be generated for a vehicle that adopts the car connectivity consortium (CCC) standard.

For example, when at least one vehicle parked in a parking lot transmits parking location information of the vehicle as a BLE advertising signal within a radius of 10 m, the user terminal 300 may receive it and recognize its own position based on the received signal (e.g., by identifying the transmitting vehicle's ID, location, or signal strength, etc.).

In this case, the location of the user terminal 300 may be recognized in two ways: one is to recognize the location of the user terminal 300 by using parking location information of a vehicle received by the user terminal 300 itself (e.g., using a single BLE advertising source, estimated RSSI, or fixed beacon coordinates, etc.), and the other is to recognize the location of the user terminal 300 by another entity (e.g., a management server 200 performing remote computation, database lookup, or triangulation, etc.).

Accordingly, the present disclosure proposes the method of recognizing the location of the user terminal 300 by the management server 200 as preferred example, but examples are not necessarily limited thereto (e.g., hybrid or decentralized implementations may also be used, etc.).

Therefore, when the user terminal 300 receives at least one parking location information transmitted from a nearby vehicle (e.g., 10_1 to 10_N, or others' vehicles 1 to N broadcasting BLE advertising packets containing location metadata, etc.), the user terminal 300 may transmit the parking location information to the management server 200. The management server 200 may then calculate the location of the user terminal 300 based on the parking location information (e.g., using signal correlation, weighted proximity, or spatial indexing, etc.).

In this case, while receiving the at least one parking location information transmitted from the nearby vehicle, the user terminal 300 may acquire a corresponding electric field strength of a received signal (e.g., RSSI, signal-to-noise ratio, or packet reception rate, etc.), along with the at least one parking location information transmitted from the nearby vehicle, and may transmit both the parking location information and the field strength of the information to the management server 200 for position estimation or proximity validation, etc.

When the management server 200 receives two or more parking location information and corresponding electric field strength from the user terminal 300, the management server 200 may calculate the location of the user terminal 300 by a triangulation method (e.g., using RSSI-based multilateration (MLAT), weighted centroid positioning, or least-squares estimation, etc.).

On the other hand, when the management server 200 receives only one parking location information and corresponding field strength from the user terminal 300, the triangulation method may not be applied, and it may thus select the location of the user terminal 300 based on the one parking location information (e.g., assuming proximity to the single detected vehicle, or using default location confidence zones, etc.).

By this process, the location of the user terminal 300 may be recognized (e.g., within an estimated range accuracy depending on BLE signal quality and beacon density, etc.).

In this case, communication between the management server 200 and the user terminal 300 may be performed on a period of a preset unit time (e.g., 1 second (sec), 500 milliseconds, or a dynamically adjusted interval based on motion detection, etc.) based on a time at which the user terminal 300 receives the parking location information from the nearby vehicle.

The preceding description is about a method in which a vehicle (e.g., 100, 10_1, and 10_N) transmits its parking location information through BLE communication, and a method in which a management server (e.g., 200) recognizes a location of a user terminal (e.g., 300) that has received parking location information from a nearby vehicle through data communication between the user terminal 300 and the management server 200 e.g., via a cellular network, Wi-Fi, or vehicle telematics link, etc.).

Here, a process in which a user vehicle (e.g., 100) recognizes the location of the user terminal 300 that is out of a short-range communication network through data communication with the management server 200 and performs UWB positioning accordingly is described below with reference to FIG. 2 (e.g., for seamless digital key activation or secure vehicle access, etc.).

FIG. 2 shows an example of the process and concept of the UWB positioning method according to an example of the present disclosure, which is based on the communication network shown in FIG. 1 as a basic premise. The user vehicle 100 may acquire its parking location information after completing parking, and may notify the user terminal 300 of the parking location information and store the parking location information such that the management server 200 may recognize a separation distance between the user vehicle 100 and the user terminal 300 (e.g., for determining proximity, enabling BLE connection, or initiating UWB ranging, etc.).

In this case, the parking location information may be provided by the user vehicle 100 directly to the user terminal 300 via the short-range communication network (BLE communication) (e.g., using ADV_NONCONN_IND packets or GATT service updates, etc.) or may be provided to the user terminal 300 via the management server 200 (e.g., through a cloud-based digital key platform, push message, or remote API call, etc.).

The method of acquiring the parking location information (e.g., using wheel odometry, G-sensor calibration, or infrastructure-based localization, etc.) is described above and is thus omitted here.

In this case, the user vehicle 100 may verify whether the user terminal 300 is registered as a digital key, and if so, may set a BLE advertising signal strength to a default value (e.g., −12 dBm or manufacturer-specific low power mode, etc.) and transmit location information of a current parking space (e.g., level B2, zone C, or coordinates (x, y), etc.).

Subsequently, when the user terminal 300 is located at a location indicated as “PA” in FIG. 2, while the user terminal 300 is returning to the parking space from a location out of a range of a short-range communication network, the user terminal 300 may be in a state where the user terminal 300 does not receive parking location information (e.g., due to distance, interference, or BLE signal loss, etc.) from a nearby vehicle (e.g., a vehicle located within BLE reception range, for example, 10 meters, a vehicle located within a threshold distance of the user terminal 300, etc.). Therefore, data communication between the user terminal 300 and the management server 200 may not be established (e.g., via cellular, Wi-Fi, or V2X uplink, etc.).

Subsequently, when the user enters a BLE communication network area (e.g., within approximately 10 meters or a predefined RSSI threshold, etc.) 10_N_B of a nearby vehicle 10_N while moving along a returning route and reaches a location indicated as “PB,” the user terminal 300 may receive at least one parking location information transmitted from the nearby vehicle 10_N (e.g., encoded in a BLE advertising packet containing coordinates, zone ID, or floor level, etc.).

In this description, it is assumed that there is only one other vehicle (e.g., 10_N) nearby, and only one parking location information is received (e.g., due to sparse vehicle distribution, signal obstruction, or parking lot geometry, etc.).

Therefore, the user terminal 300 may transmit, to the management server 200, the parking location information (e.g., (x, y) coordinates, section label, or time-stamped beacon ID, etc.) including field strength received from the other vehicle 10_N, along with the parking location information of the user vehicle 100 that is stored in advance during the parking process (e.g., through BLE provisioning, in-vehicle display, or OTA sync, etc.).

The management server 200 may first verify the parking location information of the other vehicle 10_N received from the user terminal 300 to determine whether triangulation is to be used (e.g., by checking the number of unique beacon sources, signal quality, or spatial layout constraints, etc.).

Therefore, in a case where the current location of the user terminal 300 is a location indicated as PB, there may be only one parking location information (e.g., a BLE advertisement containing coordinates or zone ID, etc.) of the nearby vehicle 10_N to be received, and thus the location of the user terminal 300 may be selected as a parking location of the nearby vehicle 10_N (e.g., assuming proximity due to highest RSSI or lack of alternative beacon signals, etc.).

Subsequently, the management server 200 may compare the parking location of the other vehicle 10_N and the parking location information of the user vehicle 100 to calculate a separation distance (e.g., in meters, based on (x, y) coordinates or mapped parking zones, etc.).

The management server 200 may determine whether the separation distance between the user vehicle 100 and the user terminal 300 is within a preset threshold range (e.g., 10 meters, 1 zone radius, or a signal propagation limit, etc.), and may determine that the location indicated as PB is out of the threshold range and may not notify the user vehicle 100 of access information of the user terminal 300 (e.g., to avoid unnecessary BLE power increase or UWB session trigger, etc.).

Then, when the user reaches a location indicated as “PC” while moving along the returning route, the user vehicle 100 may enter an area that overlaps a BLE communication network area (e.g., overlapping broadcast regions with sufficient signal strength such as −80 dBm or higher, etc.) of a nearby vehicle (e.g., 10_2_B and 10_3_B of vehicles 10_2 and 10_3, respectively).

Therefore, the user terminal 300 may transmit, to the management server 200, parking location information (e.g., BLE-based coordinates, parking bay identifiers, or section labels, etc.) including field strength received from the other vehicle (e.g., 10_2 and 10_3) along with the parking location information of the user vehicle 100 that is stored in advance during the parking process (e.g., saved via a previous BLE sync or in-vehicle update, etc.).

The management server 200 may first verify the parking location information of the other vehicle (e.g., 10_2 and 10_3) received from the user terminal 300 to determine whether triangulation is to be performed (e.g., by checking that two or more distinct signals with sufficient RSSI values are available, etc.).

For example, when the current location of the user terminal 300 is the location indicated as PC, there are two parking location information entries of the other nearby vehicle (e.g., 10_2 and 10_3) to be received, and thus the location of the user terminal 300 may be determined through the field strength (e.g., RSSI-based weighting or signal-to-distance mapping, etc.) based on the parking location of the nearby vehicle (e.g., 10_2 and 10_3) by triangulation (e.g., using a centroid calculation or least-squares multilateration algorithm, etc.).

The management server 200 may then compare the location of the user terminal 300 measured by triangulation based on the parking location of the other vehicle (e.g., 10_2 and 10_3, using RSSI or time-of-arrival estimates, etc.) and the parking location information of the user vehicle 100 to calculate the separation distance (e.g., in meters, parking slots, or zones, etc.).

The management server 200 may determine whether the separation distance between the user vehicle 100 and the user terminal 300 is within the preset threshold range (e.g., 5 meters, one parking bay, or a predefined UWB activation radius, etc.). In this case, when the location indicated as PC is determined as a location that is near or enters the threshold range, the management server 200 may notify the user vehicle 100 of the access information of the user terminal 300 via the data communication network (e.g., using LTE, 5G, Wi-Fi, or vehicle telematics, etc.).

When the user vehicle 100 receives, from the management server 200, the access information indicating that the user terminal 300 is approaching within the threshold range, the user vehicle 100 may expand an area 100_B affected by the signal strength of the BLE communication, which is initially set as a default value (e.g., −12 dBm or minimal broadcast mode, etc.), and may gradually increase it based on a preset increment value (e.g., +4 dB per step, or adaptive gain control, etc.) up to a range indicated as reference numeral 100_EB (e.g., maximum BLE coverage zone or effective pairing radius, etc.).

While the user vehicle 100 is expanding the area affected by the signal strength of the BLE communication after the data communication between the management server 200 and the user vehicle 100 is established, when the user approaches within the expanded area (e.g., 100_EB representing a higher BLE transmission power coverage area, such as +4 dBm to 0 dBm, etc.) with the increased signal strength of the BLE communication by the user vehicle 100 while returning from the PC point where the location is recognized to the user vehicle 100, the BLE communication may be established (or connected) between the user terminal 300 carried by the user and the user vehicle 100 (e.g., enabling encrypted session setup, digital key verification, or secure channel negotiation, etc.).

When the BLE communication connection with the user terminal 300 is established, the user vehicle 100 may perform a UWB communication connection with the user terminal 300. In this case, the user vehicle 100 may set a field strength for the UWB communication connection as a preset default value (e.g., initial ranging request at −10 dBm or predefined session start level, etc.).

If the user vehicle 100 performs the UWB communication connection with the user terminal 300 based on the default value, but the actual connection is not established, the field strength for the UWB communication connection may be increased based on the preset increment value (e.g., +2 dB per attempt, exponential backoff, or dynamic range adjustment, etc.) and performed again (e.g., until a response is received or a timeout condition is met, etc.).

The user vehicle 100 to which the UWB positioning method according to examples of the present disclosure is applied, performing the operating process as described above, may be configured as shown in FIG. 3 (e.g., including BLE/UWB circuitry, control circuit, and wireless interface circuitry, etc.).

Referring to FIG. 3, the user vehicle 100 may include a vehicle controller 120 configured to provide a remote control command for locking/unlocking the doors and opening/closing the trunk of the user vehicle 100, a remote control command for start on/off, or a payment method such that a payment is made using an external payment terminal (e.g., a toll booth, charging station, or drive-through kiosk, etc.), and a vehicle authentication device 110 to which a multi-communication method is applied (e.g., combining BLE, UWB, NFC, or cellular connectivity, etc.).

In this case, the vehicle authentication device 110 may include: a BLE communication unit 114 configured to perform Bluetooth communication with the user terminal 300 (e.g., a device such as a smartphone, smartwatch, or smart key fob, etc.) located outside, a UWB communication unit 115 configured to perform UWB communication with the user terminal 300 (e.g., for secure ranging and precise positioning, etc.), a mobile communication connection unit 113 configured to perform communication with the management server 200 using a mobile communication service network (e.g., a data communication network), LTE, 5G, or Wi-Fi hotspot, etc.) a storage unit 111 configured to store authentication information for authenticating the user terminal 300 (e.g., digital certificates, public keys, or unique device IDs, etc.), a user authentication unit 112 configured to authenticate the user terminal 300 based on the authentication information stored in the storage unit 111 and authentication request information received from the user terminal 300 (e.g., BLE handshake data, encrypted challenge responses, or token-based credentials, etc.), and a communication control unit 117 configured to control the operations of the storage unit 111, the user authentication unit 112, the BLE communication unit 114, the UWB communication unit 115, and the mobile communication connection unit 113 (e.g., scheduling tasks, managing power levels, or coordinating session transitions, etc.).

In this case, the mobile communication connection unit 113 may connect to the management server 200 using a mobile communication service network (e.g., a data communication network such as LTE, 5G, or Wi-Fi, etc.), and receive access information generated when the user terminal 300 approaches within a preset threshold range under the control of the management server 200 (e.g., based on GPS proximity, BLE triangulation, or signal strength estimation, etc.).

Further, the BLE communication unit 114, which is a communication module for performing wireless communication in a Bluetooth communication method with the user terminal 300, may transmit and receive wireless signals of a preset frequency band (e.g., 2.402 GHz to 2.480 GHz in the ISM band, etc.) through an antenna (not shown).

In this case, the BLE communication unit 114 may be implemented in the form of a communication module capable of performing BLE communication. Here, BLE is a protocol provided with the advent of Bluetooth 4.0 version, and is a Bluetooth-based communication protocol that focuses on reducing or minimizing power consumption and extending battery life. It is relatively slow compared to other wireless transmission standards, but due to its low power characteristics, it may be used particularly for wearable devices (e.g., fitness trackers, smartwatches, or wireless earbuds, etc.).

Further, the UWB communication unit 115, which is a communication module for performing wireless communication of the UWB communication method with the user terminal 300, may transmit and receive wireless signals of a preset frequency band (e.g., 6.5 GHz to 8 GHz under IEEE 802.15.4a/z, etc.) through an antenna (not shown) (e.g., integrated into the vehicle frame, mirror housing, or dashboard, etc.).

Further, the storage unit 111 may store pairing information, authentication information, and encryption information, and the like of the user terminal 300 (e.g., digital key credentials, UUIDs, or session tokens, etc.). For example, the pairing information and the authentication information of the user terminal 300 may be registered by the communication control unit 117 during initial communication with the user terminal 300 via the BLE communication unit 114 (e.g., during a pairing handshake or key exchange procedure, etc.).

Further, the pairing information and the authentication information may be received from the management server 200 via the mobile communication connection unit 113 and may be stored by the communication control unit 117 in the storage unit 111 together with the encryption information (e.g., AES keys, ECDH public/private keys, or session-specific certificates, etc.).

Further, the encryption information may include information necessary to encrypt and decrypt signals when the BLE communication unit 114 communicates with the user terminal 300 (e.g., for secure pairing, message integrity, or data confidentiality, etc.).

Further, the communication control unit 117 may perform overall control necessary to communicate with the user terminal 300 via the BLE communication unit 114 and the UWB communication unit 115 (e.g., coordinating signal timing, managing power consumption, or switching communication states, etc.). For example, the communication control unit 117 may increase the advertising signal transmission strength when the BLE communication unit 114 transmits an advertising signal and receives the access information via the mobile communication connection unit 113 to expand a range over which BLE communication is available (e.g., increasing from a default low-power state to a higher or a maximum permitted Tx level, such as +4 dBm, in response to proximity detection, etc.).

Further, the communication control unit 117 may provide the authentication request information received from the BLE communication unit 114 and the UWB communication unit 115 to the user authentication unit 112, and may control the user authentication unit 112 or the storage unit 111 such that the user authentication unit 112 may authenticate the user terminal 300 using authentication data stored in the storage unit 111 (e.g., device-specific keys, digital certificates, or pre-registered user profiles, etc.).

Further, the communication control unit 117 may control the vehicle communication unit 116 to perform communication with the vehicle controller 120 provided in the user vehicle 100 (e.g., to trigger door lock actions, engine start sequences, or payment workflows, etc.).

Here, the vehicle communication unit 116 may communicate with the vehicle controller 120 according to a controller area network (CAN) communication standard (e.g., ISO 11898, CAN FD, or FlexRay interface, etc.) to transmit a remote control command or the like transmitted from and received by the user terminal 300, such that remote control commands for locking/unlocking the doors and opening/closing the trunk of the user vehicle 100, as well as remote control commands for starting on/off, or payment using an external payment terminal or the like using a payment method provided in the vehicle 100 may be performed (e.g., toll payment, EV charging authentication, or contactless drive-thru payment, etc.).

It is to be noted that each of the communication modules may be implemented with a memory storing a program for performing the functions and a processor executing the program, and that respective memories of the modules may be integrated into one or more memories, and that respective processors of the modules may be integrated into one or more processors (e.g., as a system-on-chip, MCU cluster, or ECU architecture, etc.).

Further, the storage unit 111 may temporarily store parking location information acquired by the vehicle controller 120 (e.g., in non-volatile memory or cache for short-term use, etc.). In this case, the method of acquiring the parking location information (e.g., wheel sensor-based tracking, V2I communication, or map-assisted estimation, etc.) stored in the storage unit 111 has been described above, and a detailed description thereof is omitted here.

Therefore, briefly describing the UWB positioning method based on the method of transmitting a parking location of a vehicle and the method of recognizing a current location of a user, according to examples of the present disclosure, the user vehicle 100 may acquire parking location information of the vehicle (e.g., generated based on the information from the wheel sensor, the steering sensor, or the G-sensor such as odometry, steering angle tracking, or acceleration data fusion, etc.) when the user vehicle 100 enters a underground parking lot and parks, and may then directly register it with the user terminal 300 possessed by the user or share a detailed parking location of the vehicle through the management server 200 (e.g., via BLE packet, local display sync, or cloud-based digital key system, etc.). In this case, the digital key of the user terminal 300 may store the information (e.g., in local app storage, secure enclave, or keychain database, etc.).

Not only the user vehicle 100, but also other vehicles (e.g., 10_1 to 10_N) to which the method according to examples of the present disclosure is applied may periodically transmit their parking location information (e.g., using BLE advertising every few seconds, in response to motion detection, or on ignition-off events, etc.).

The management server 200 may recognize and update the current location of the user terminal 300 through an advertising signal including the parking location information received from the other vehicles (e.g., 10_1 to 10_N broadcasting BLE advertisements containing location data, device IDs, or parking zone codes, etc.) among nearby vehicles located on a route on which the user terminal 300 storing therein the digital key of the user returns to the user vehicle 100 (e.g., while navigating through a multi-level or underground parking structure, etc.).

Therefore, when the management server 200 determines that the user terminal 300 is present in a threshold radius range of the user vehicle 100 (e.g., within 10 meters or within BLE signal coverage, etc.) or the same floor of the parking space set by the user based on the parking location information of the user vehicle 100, the management server 200 may transmit a digital key access status of the user terminal 300 to the user vehicle 100 (e.g., as a trigger to begin BLE handshaking or initiate secure channel setup, etc.).

In this case, when the access information of the digital key is received from the management server 200, the user vehicle 100 may gradually increase the BLE advertising transmission strength to the maximum threshold field strength based on a preset increment (e.g., from −16 dBm to +4 dBm in steps of 2 dB, etc.). This may be performed until the BLE connection succeeds (e.g., as confirmed by acknowledgment packets or session initialization, etc.).

When the BLE communication connection has succeeded, the user vehicle 100 may establish a UWB session via BLE and may then perform positioning on the user terminal 300 via UWB. The increased BLE transmission strength may be adjusted to a stable communication level (e.g., based on real-time RSSI feedback, connection quality, or noise floor measurements, etc.) by referring to an RSSI value of a BLE signal received from a smartphone. When the user is located at a location near the vehicle based on the location information of the digital key, UWB positioning may be performed (e.g., for verifying precise proximity before unlocking doors, starting the engine, or enabling interior personalization, etc.).

An example of the present disclosure is to provide an ultra-wideband (UWB) positioning method and system that relates to a data communication platform for digital key recognition between a vehicle owned by a user and a registered user terminal, which may enable the vehicle to recognize in advance a separation distance from a user who is returning from outside a range of short-range wireless communication.

In this case, a management server for the UWB positioning method according to an example of the present disclosure may, when the user terminal receives at least one parking location information from another nearby vehicle and transmits this, measure a location of the user terminal based on the parking location information, calculate a distance based on parking location information of the vehicle, and when the distance is determined to be within a preset threshold range, notify the vehicle of the proximity of the user terminal.

According to at least one example of the present disclosure, there is provided an ultra-wideband (UWB) positioning method including: acquiring, by the vehicle, parking location information of the vehicle, notifying, by the vehicle, a registered user terminal of the parking location information, transmitting, by the vehicle, the parking location information via an advertising signal of Bluetooth Low Energy (BLE) communication, determining, by the vehicle, whether access information of the user terminal is received from a management server, and in response to a determination that the access information is received, preparing, by the vehicle, a UWB communication connection.

The acquiring the parking location information may comprise acquiring the parking location information of the vehicle through driving-related data, and the notifying the registered user terminal of the parking location information may comprise providing the parking location information to the user terminal equipped with a digital key.

The providing the parking location information to the user terminal equipped with a digital key may comprise providing the parking location information of the vehicle from the vehicle directly to the user terminal via a short-range communication network.

The providing the parking location information to the user terminal equipped with a digital key may comprise providing the parking location information of the vehicle to the user terminal via the management server.

The parking location information may be generated based on information from a wheel sensor, a steering sensor, and a G-sensor.

The parking location information may be generated based on information from a wheel sensor, a steering sensor, and a G-sensor, using a detailed map of a parking space.

The parking location information is generated based on information from a wheel sensor, a steering sensor, and a G-sensor, using information acquired through communication between infrastructures of a parking space based on a vehicle-to-infrastructure (V2I) technology.

The access information may be generated by the management server when the user terminal approaches within a preset threshold range, with respect to the parking location information of the vehicle, or the access information may be generated when the user terminal is determined to approach within the preset threshold range, based on location information of a nearby vehicle acquired by the user terminal from a BLE advertising signal of the nearby vehicle.

The preparing the UWB communication connection may include accumulating a transmission strength of the advertising signal by a preset increment to a preset default value.

The preparing the UWB communication connection may include gradually accumulating a transmission strength of the advertising signal by a preset increment to a preset default value up to a preset maximum transmission strength.

The preparing the UWB communication connection may include switching a UWB communication module to a wait mode.

The preparing the UWB communication connection may include, when the BLE communication connection is established between the vehicle and the user terminal, performing a UWB communication connection with the user terminal.

According to at least one example of the present disclosure, there is provided a method of operating a management server for an ultra-wideband (UWB) positioning of a vehicle, the method including: in response to receiving parking location information of the vehicle, storing and registering, by management server, the parking location information with pre-registered digital key information; in response to receiving, from a user terminal, parking location information of at least one other vehicle located near the user terminal, determining, by management server, a current location of the user terminal; calculating, by management server, a distance between the current location of the user terminal and the parking location information of the vehicle; and in response to a determination that the distance is within a preset threshold range, transmitting, by management server, access information of the user terminal to the vehicle.

The determining the current location of the user terminal may include: when there is only one parking location received from the user terminal, determining the parking location information of the other vehicle as the current location of the user terminal.

The determining the current location of the user terminal may include: when there are two or more parking locations received from the user terminal, determining the current location of the user terminal by triangulation based on the two or more parking locations.

According to at least one example of the present disclosure, there is provided a UWB positioning system of a vehicle including: a vehicle controller configured to detect an operating state of the vehicle and control the vehicle; a BLE communication unit configured to perform Bluetooth communication with a user terminal; a UWB communication unit configured to perform UWB communication with the user terminal; a wireless communication connection unit configured to communicate with a management server; a storage unit configured to store authentication information for authenticating the user terminal; a user authentication unit configured to authenticate the user terminal based on the authentication information stored in the storage unit and authentication request information transmitted from the user terminal; and a communication control unit configured to control operations of the storage unit, the user authentication unit, the BLE communication unit, the UWB communication unit, and the wireless communication connection unit. The communication control unit may be configured to: acquire parking location information of the vehicle via the vehicle controller, notify the user terminal of the parking location information of the vehicle, determine whether access information of the user terminal is received from the management server, and when it is determined that the access information is received from the management server, prepare a UWB communication connection.

The communication control unit may be configured to: acquire the parking location information of the vehicle from driving-related data via the vehicle controller and provide the parking location information of the vehicle to the user terminal equipped with a digital key.

The communication control unit may be configured to: when preparing the UWB communication connection, accumulate a transmission strength of a BLE advertising signal to a preset default value by a preset increment.

The communication control unit may be configured to: when preparing the UWB communication connection, gradually accumulate a transmission strength of a BLE advertising signal to a preset default value by a preset increment up to a preset maximum transmission strength.

The communication control unit may be configured to: when the BLE communication connection is established with the user terminal, perform the UWB communication connection with the user terminal.

At least one example of the present disclosure provides an UWB positioning method based on a method of transmitting a parking location of a vehicle of a user and a method of recognizing a current location of the user, which may detect an approach of the user from a long distance (e.g., an area beyond a BLE connectivity range) using advertising signals of nearby vehicles when a smartphone is present in an environment (e.g., a hip pocket, an underground parking lot, etc.) that may degrade BLE transmission and reception performance.

In this case, when the approach of the user from a long distance is verified while the user is passing by a nearby vehicle, the smartphone may share access information about this approach with the vehicle. The owned vehicle that has received such a signal may determine whether the user is approaching within a certain range by increasing communication strength until BLE communication is connected, and when the smartphone is located within a certain range from the owned vehicle, may adjust the BLE transmission power strength and acquire maximal BLE connectivity performance even though the smartphone is in a bad BLE transmission and reception condition.

Therefore, since a communication execution start time of UWB communication, which is communication consumes high power, is determined through BLE communication, which is communication consumes low power, the BLE connectivity performance may be closely related to UWB positioning performance, and a positioning delay caused by the failure of BLE connection may be overcome.

Further, to overcome the challenge that the default power consumption of the vehicle is set high for transmitting a BLE advertising signal permanently at a high level, which may adversely affect battery life and wait time, advertising (ADV) may be performed by default when the user is at a remote location or global positioning system (GPS) information is not received based on a relative location between the owned vehicle and the smartphone of the user, and the communication may be connected by increasing the BLE communication strength when a GPS-based distance to the vehicle decreases.

Further, when the advertising strength is set high, a UWB ranging timer may end (e.g., the timer ends when no additional ranging trigger signal is input after ranging is performed for a certain time period by a high-power consuming UWB ranging method) while the user is approaching the vehicle after the connection to the vehicle at a long distance, determining whether BLE connection is necessary based on the location of the user and increasing the ranging timer when the distance to the vehicle is close may enhance user convenience.

Accordingly, one example of the present disclosure provides a UWB positioning method based on a method of transmitting a parking location of a vehicle and a method of recognizing a current location of a user, which may detect access (approach) of the user from a long distance (e.g., 10 meters or more, or an area beyond a BLE connectivity range, etc.) using an advertising signal of a nearby vehicle in an environment of a smartphone (i.e., user terminal) that may degrade BLE transmission and reception performance, such as, for example, an underground parking lot, a hip pocket, or the like (e.g., inside a backpack, obstructed by metal structures, or shielded by the user's body, etc.).

In this case, when the user checks the access from a long distance while passing by the nearby vehicle, the smartphone may share access information with the vehicle (e.g., via a cloud server, indirect BLE relay, or pre-shared session ID, etc.). Upon receiving such a signal, the vehicle owned by the user may determine whether the user is approaching (i.e., access) within a certain range by increasing the communication strength until BLE communication is connected, and if the smartphone is located within a certain range relative to the vehicle, the smartphone may adjust the BLE transmission strength to secure maximum BLE connection performance (e.g., boosting transmission power, retrying advertisements, or switching antenna modes, etc.) even if the BLE transmission and reception environment of the smartphone is bad (e.g., due to attenuation, interference, or physical obstructions, etc.).

Therefore, in general, a communication execution time of UWB communication (which is high-power communication) may be determined based on BLE communication (which is low-power communication), and the BLE connection performance may be closely related to the UWB positioning performance (e.g., UWB session is triggered only after BLE pairing succeeds, etc.), and thus a positioning delay caused by the failure of BLE connection may be overcome (e.g., by adapting BLE signal strength based on proximity or retry thresholds, etc.).

In addition, to overcome a technical challenge that the default power consumption of a vehicle may be set to high if a BLE advertising signal is always transmitted at high strength, which may adversely affect battery life and wait time (e.g., increased standby drain, reduced key-off duration, etc.), ADV by default may be performed when the user is at a distant location or GPS information is not received based on a relative location between the owned vehicle and the smartphone of the user, and communication may be connected by increasing the BLE communication strength when the distance to the vehicle becomes close based on GPS (e.g., within a geofence radius or using assisted GPS/RTK inputs, etc.).

Further, if the ADV strength is set high, the UWB ranging timer may end while the user is approaching the vehicle in connection with the vehicle at a long distance (e.g., triggering premature timeout if user walks slowly or if no BLE reconnection occurs, etc.). A UWB ranging method that uses high power performs ranging for a certain amount of time, and the timer expires if no additional ranging trigger signal is input). Thus, whether a BLE connection is necessary may be determined based on the location of the user (e.g., estimated from BLE signal strength, GPS data, or triangulation, etc.). And the ranging timer may be increased if the distance to the vehicle is close to improve user convenience (e.g., by extending the timeout window or dynamically adjusting it based on movement patterns, etc.).

While preferred examples of the present disclosure have been shown and described above, the present disclosure is not limited to the specific examples described above, various changes and modifications may be made by one of ordinary skill in the art to which the present disclosure pertains without departing from the spirit and scope of the disclosure, and such changes and modifications should not be construed as being independent of the technical ideas or views of the present disclosure.

What is claimed:

1. A method performed by an apparatus for a vehicle, the method comprising:
obtaining parking location information of the vehicle;
providing the parking location information to a user terminal;
after providing the parking location information and after the user terminal is wirelessly disconnected from the vehicle, transmitting, using a Bluetooth Low Energy (BLE) transceiver of the vehicle, a BLE signal comprising the parking location information;
after transmitting the BLE signal, determining whether access information of the user terminal is received from a server; and
based on a determination that the access information is received, initiating, using an ultra-wideband (UWB) transceiver of the vehicle, a UWB communication connection between the vehicle the user terminal.

2. The method of claim 1, wherein the obtaining the parking location information comprises obtaining, based on driving-related data, the parking location information, and
wherein the user terminal is equipped with a digital key associated with the vehicle.

3. The method of claim 1, wherein the providing the parking location information to the user terminal comprises:
providing, from the vehicle and via a short-range communication network, the parking location information to the user terminal.

4. The method of claim 1, wherein the providing the parking location information to the user terminal comprises:
providing the parking location information of the vehicle to the user terminal via the server.

5. The method of claim 1, wherein the parking location information is generated based on information from at least one of a wheel sensor, a steering sensor, or a gravity-sensor.

6. The method of claim 1, wherein the parking location information is generated using a map of a parking space based on information from at least one of a wheel sensor, a steering sensor, or a gravity-sensor.

7. The method of claim 1, wherein the parking location information is generated based on:
information from at least one of a wheel sensor, a steering sensor, or a gravity-sensor, and
information obtained through wireless communication between the vehicle and external devices located in a parking space.

8. The method of claim 1, further comprising:
causing the server to generate the access information based on the user terminal approaching a location within a preset threshold range from a parking location of the vehicle indicated by the parking location information; or
causing the server to generate the access information based on the user terminal being determined to approach a location within the preset threshold range from the parking location of the vehicle, wherein the generation of the access information is based on location information of a second vehicle from which the user terminal receives a BLE signal comprising parking location information of the second vehicle,
wherein a distance between the vehicle and the second vehicle is within a predetermined threshold distance.

9. The method of claim 1, wherein the initiating the UWB communication connection comprises:
retransmitting the BLE signal with an increased signal transmission strength; and
after receiving a response responsive to the retransmitted BLE signal, initiating the UWB communication connection.

10. The method of claim 1, wherein the initiating the UWB communication connection comprises:
gradually increasing a signal transmission strength of the BLE signal by a preset increment to a preset default value up to a preset maximum transmission strength.

11. The method of claim 1, wherein the initiating the UWB communication connection comprises:
setting the UWB transceiver to a standby state, wherein the UWB transceiver is configured to measure a distance between the vehicle and the user terminal via UWB signaling.

12. The method of claim 1, wherein the initiating the UWB communication connection comprises:
based on the communication connection being established between the vehicle and the user terminal, establishing a UWB communication connection with the user terminal.

13. A method performed by a server, the method comprising:
based on receiving parking location information of a vehicle, storing and registering the parking location information with pre-registered digital key information;
based on receiving, from a user terminal, parking location information of at least one other vehicle located within a threshold distance from the user terminal, determining a current location of the user terminal, wherein the user terminal is equipped with a digital key associated with the vehicle, and wherein the digital key corresponds to the pre-registered digital key information;
determining a distance between the current location of the user terminal and a parking location of the vehicle, wherein the parking location is indicated by the parking location information of the vehicle; and
based on a determination that the distance is within a preset threshold range, transmitting access information of the user terminal to the vehicle.

14. The method of claim 13, wherein the determining the current location of the user terminal comprises:
based on only one parking location received from the user terminal, determining, based on the parking location information of the at least one other vehicle, the current location of the user terminal.

15. The method of claim 13, wherein the determining the current location of the user terminal comprises:
based on two or more parking locations received from the user terminal, determining the current location of the user terminal by triangulation based on the two or more parking locations.

16. A system for a vehicle, the system comprising:
a vehicle control circuit configured to detect an operating state of the vehicle and control the vehicle;
a Bluetooth Low Energy (BLE) communication circuit configured to perform a first-type of communication with a user terminal;
an ultra-wideband (UWB) communication circuit configured to perform a second-type of communication with the user terminal;
a wireless communication circuit configured to communicate with a server;
a processor; and
a memory storing at least one instruction that, when executed by the processor communicating with the memory, is configured to cause the system to:
obtain parking location information of the vehicle,
provide the parking location information of the vehicle to the user terminal,
after providing the parking location information and after the user terminal is wirelessly disconnected from the vehicle, transmit, using the BLE communication circuit, a BLE signal comprising the parking location information,
after transmitting the BLE signal, determine whether access information of the user terminal is received from the server, and
based on a determination that the access information is received from the server, initiate, using the UWB communication circuit, a UWB communication connection between the vehicle and the user terminal.

17. The system of claim 16, wherein the at least one instruction, when executed by the processor communicating with the memory, is further configured to cause the system to:
obtain the parking location information of the vehicle from driving-related data via the vehicle control circuit; and
provide the parking location information to the user terminal, wherein the user terminal is equipped with a digital key associated with the vehicle.

18. The system of claim 16, wherein the at least one instruction, when executed by the processor communicating with the memory, is configured to cause the system to initiate the UWB communication connection by:
retransmitting the BLE signal with an increased signal transmission strength; and
after receiving a response responsive to the retransmitted BLE signal, initiating the UWB communication connection.

19. The system of claim 16, wherein the communication control unit is further configured to:
when preparing the UWB communication connection, gradually accumulate a transmission strength of a BLE advertising signal to a preset default value by a preset increment up to a preset maximum transmission strength.

20. The system of claim 16, wherein the communication control unit is further configured to:
when the BLE communication connection is established with the user terminal, perform the UWB communication connection with the user terminal.
